(19) United States
(12) Patent Application Publication
(10) Pub. No.: US 2025/0088968 A1
(43) Pub. Date: Mar. 13, 2025

(54) LOW-POWER WAKE-UP RECEIVER FOR DEVICES WITH LOW LATENCY

(71) Applicant: Sony Group Corporation, Tokyo (JP)

(72) Inventors: Nafiseh Seyed MAZLOUM, Lund (SE); Basuki PRIYANTO, Lund (SE); Torgny PALENIUS, Barsebäck (SE); Anders BERGGREN, Lund (SE)

(21) Appl. No.: 18/727,592

(22) PCT Filed: Jan. 20, 2023
(86) PCT No.: PCT/EP2023/051332

§ 371 Date: Jul. 9, 2024

(30) Foreign Application Priority Data
Jan. 28, 2022 (SE) 2250080-5

(51) Int. Cl. H04W 52/02; H04W 74/0833

(52) U.S. Cl. CPC H04W 52/0235; H04W 52/0216; H04W 52/0274; H04W 74/0833

(57) ABSTRACT

Examples provide a method of operating a mobile device (UE) in a power save mode comprising: obtaining (4010) a first power save mode configuration indicative of a time schedule for pre-defined main signal time intervals (3411, 3412, 3413) and a time schedule for pre-defined low power wake-up signal time intervals (3421, 3422, 3423), and a second power save mode configuration associated with an always on operation; operating (4030) the UE in a first power save mode (3400) upon obtaining (4020) a trigger for the UE to operate in the first power save mode (3400), wherein operating (4030) in the first power save mode (3400) comprises: monitoring (4031) for low power wake-up signals (3403) in accordance with the time schedule of the pre-defined low power wake-up signal time intervals (3421, 3422, 3423); and communicating (4032), in response to detecting a low power wake-up signal (3403) in one (3422) of the pre-defined low power wake-up signal time intervals (3421, 3422, 3423), a main signal in a main signal time interval (3412) of the pre-defined main signal time intervals (3411, 3412), and operating (4050) the UE in a second power save mode (3500) upon obtaining (4040) a trigger for the UE to operate in the second power save mode (3500), wherein operating in the second power save mode (3500) comprises: continuously monitoring (4051) for a low power wake-up signal (3503); and communicating (4052), in response to detecting a low power wake-up signal (3403), a main signal in a main signal time interval (3512) that depends on a time of detecting the low power wake-up signal (3503). Further examples provide a corresponding method of operating an access node (AN) a corresponding UE and a corresponding AN.

### TECHNICAL FIELD

Various examples relate to method of operating a mobile device in a power save mode.

### BACKGROUND

Energy efficiency is a key design requirement for a mobile device (UE) with limited energy resources, e.g., a UE using a small rechargeable and single coin cell battery. In some use cases, UEs may comprise sensors and actuators and may be deployed in a large number for monitoring, measuring, charging, etc. In many of these cases, the batteries of the UEs may not be rechargeable and are expected to last at least few years as described in 3GPP TR 38.875 Version 17.0. UEs may also comprise wearables such as smart watches, rings, eHealth related devices, and medical monitoring devices. Taking into account a typical battery capacity, it is challenging to sustain operation of the UE up to 1-2 weeks as often required. It has been proposed to activate (wake-up) a receiver of a UE only periodically, for example, only once per pre-defined discontinuous reception (DRX) cycle. The periodic activation of the receiver may dominate the power consumption of the UE in periods free of signaling or data traffic.

Using a low power wake-up receiver, e.g. an extra ultra-low power wake-up receiver (LP-WuRX) at a UE and activating the aforementioned receiver (hereinafter: main receiver) according to the DRX cycle only in response to detecting a wake-up signal with the low power wake-up receiver may significantly reduce the energy consumption associate with channel listening/monitoring, in particular, if the low power wake-up receiver is also operating based on a discontinuous reception cycle.

However, while the proposed power modes may reduce power consumption they may lead to increased latency. Such an increased latency may not be acceptable in some use cases, for example, in case a UE has to respond to an alarm induced by a detected fault having occurred during manufacturing (e.g. in a manufacturing process in a factory).

Accordingly, there may be a need for a method supporting UEs with both limited energy resources and a required upper limit of a communication delay.

### SUMMARY

Said need has been addressed with the subject matter of the independent claims. Advantageous embodiments are described in the dependent claims.

Examples provide a method of operating a mobile device (UE) in a power save mode comprising: obtaining a first power save mode configuration indicative of a time schedule for pre-defined main signal time intervals and a time schedule for pre-defined low power wake-up signal time intervals and a second power save mode configuration associated with an always on operation; operating the UE in a first power save mode upon obtaining a trigger for the UE to operate in the first power save mode, wherein operating in the first power save mode comprises: monitoring for low power wake-up signals in accordance with the time schedule of the pre-defined low power wake-up signal time intervals; and communicating, in response to detecting a low power wake-up signal in one of the pre-defined low power wake-up signal time intervals, a main signal in a main signal time interval of the pre-defined main signal time intervals, and operating the UE in a second power save mode upon obtaining a trigger for the UE to operate in the second power save mode, wherein operating in the second power save mode comprises: continuously monitoring for a low power wake-up signal; and communicating, in response to detecting a low power wake-up signal, a main signal in a main signal time interval that depends on a time of detecting the low power wake-up signal.

Examples provide a method of operating an access node (AN) comprising obtaining, for a UE, a first power save mode configuration indicative of a time schedule for pre-defined main signal time intervals and a time schedule for pre-defined low power wake-up signal time intervals, and a second power save mode configuration associated with an always on operation; wherein operating the UE in the first power save mode comprises: monitoring for low power wake-up signals in accordance with the time schedule of the pre-defined low power wake-up signal time intervals; and communicating, in response to detecting a low power wake-up signal in one of the pre-defined low power wake-up signal time intervals, main signals in a main signal time interval of the pre-defined main signal time intervals, and wherein operating the UE in the second power save mode comprises: continuously monitoring for a low power wake-up signal; and communicating, in response to detecting a low power wake-up signal, main signals in a main signal time interval that depends on a time of detecting the low power wake-up signal; transmitting, to the UE, a low power wake-up signal in accordance with the first power save mode upon evaluating that the UE operates in the first power save mode, transmitting, to the UE, a low power wake-up signal in accordance with the second power save mode upon evaluating that the UE operates in the second power save mode.

Further examples provide a UE comprising control circuitry, wherein the control circuitry is configured for performing a method described above.

Additional examples provide an AN comprising control circuitry, wherein the control circuitry is configured for performing a method described above.

### BRIEF DESCRIPTION OF THE DRAWINGS

FIG. 1 schematically illustrates communication a communication network.

FIG. 2 schematically illustrates a UE and an AN.

FIG. 3 schematically illustrates power modes.

FIG. 4 schematically illustrates a method of operating a UE.

FIG. 5 schematically illustrates a method of operating an AN.

FIG. 6 schematically illustrates selecting a power save mode.

FIG. 7 schematically illustrates signaling in a communication network.

### DETAILED DESCRIPTION

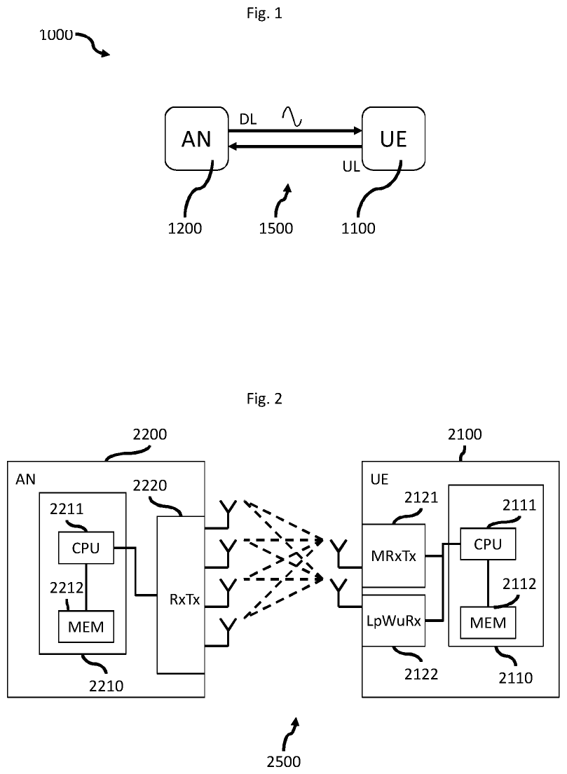

FIG. 1 illustrates an exemplary communication network 1000 according to some examples implementations. The communication network 1000 may include a cellular network. In particular, the communication network 1000 according to the example of FIG. 1 may implement a 3GPP LTE architecture, sometimes referred to as evolved packet system (EPS). The communication network 1000 may also implement a 5G Core Network (5GC). In the following, scenarios will be explained in the context of a wireless link 1100 between a UE 1100 and an access node 1100 of the communication network 1000 operating according to the 3GPP NR radio access technology (RAT) or the 3GPP LTE RAT, particularly LTE MTC. Similar techniques can be readily applied to various kinds of 3GPP-specified RATs, such as Global Systems for Mobile Communications (GSM), Wideband Code Division Multiplex (WCDMA), General Packet Radio Service (GPRS), Enhanced Data Rates for GSM Evolution (EDGE), Enhanced GPRS (EGPRS), Universal Mobile Telecommunications System (UMTS), and High Speed Packet Access (HSPA), and corresponding architectures of associated cellular networks. Similar techniques may also be applied to 5G New Radio (NR), and NR-IoT.

A further particular example is the 3GPP NB-IoT RAT. The 3GPP NB-IoT RAT may be based on the 3GPP LTE RAT, i.e., the Evolved UMTS Terrestrial Radio Access (E-UTRA). Further, the NB-IoT RAT may be combined with the EPS as illustrated in FIG. 1. Examples disclosed herein may be used for the 3GPP NB-IoT RAT, alternatively or additionally.

Other examples include other types of networks, e.g., Institute of Electrical and Electronics Engineers (IEEE) 802.11X Wireless Local Area Network, Bluetooth or Zigbee.

The UE 1100 is connected via the wireless link 1500 to an access node (AN) 1100 of the communication network 1000. In an example, The UE 1100 and the AN 1200 may implement an evolved UMTS terrestrial radio access technology (E-UTRAN) or a 5G technology standard. Accordingly, the AN 1200 may in particular implement an evolved node B (eNB) or a Next generation node B (gNB).

In examples, the UE 1100 may be selected from a group including: a smartphone; a cellular phone; a table; a notebook; a computer; a smart TV; a MTC device, an IoT device; eMTC, a RedCap device; etc.

An MTC, eMTC, RedCap, or IoT device is typically a device with a low to moderate requirement on data traffic volumes. Additionally, communication employing those devices should achieve low complexity and low costs. Further, energy consumption of an MTC, eMTC, RedCap or an IoT device should be comparably low in order to allow battery-powered devices to function for a comparably long duration: The battery life should be sufficiently long. For example, the IoT device may be connected to the EPS (or 5GC) via the NB-IoT RAT.

Communication on the wireless link 1500 may be in an uplink (UL) and/or a downlink (DL) direction.

FIG. 2 illustrates further details of an AN 2200 and a UE 2100 communicating via a wireless link 2500. The AN 2200 comprises control circuitry 2210 for operating the AN 2200, in particular according to methods described below. The control circuitry 2210 may comprise a processor 2211 and memory 2212. The AN 2200 further includes a transceiver 2220 configured for receiving and/or transmitting signals on the wireless link 2500. Likewise, the UE 2100 includes control circuitry 2110 for operating the UE 2100, in particular according to methods described below. The control circuitry 2110 may include a processor 2111 and memory 2112. The UE 2100 includes a main transceiver 2121 and a low power wake-up receiver 2122. The main transceiver 2121 may be configured to receive and/or transmit many type of signals, which may be communicated on the wireless link 2500 according to a standard which the communication network implements. The low power wake-up receiver 2122 may consume less power when activated compared to the main transceiver 2121. The low power wake-up receiver 2122 may only be capable of detecting and/or receiving signals on the wireless link 2500. The low power wake-up receiver 2122 may not be capable of transmitting signals on the wireless link 2500. In particular, the low power wake-up receiver 2122 may only be capable of detecting and/or receiving low power wake-up signals. The low power wake-up receiver 2122 may not be capable of receiving main signals. The main transceiver 2121 and the low power wake-up receiver may share the same antenna and/or RF front-end.

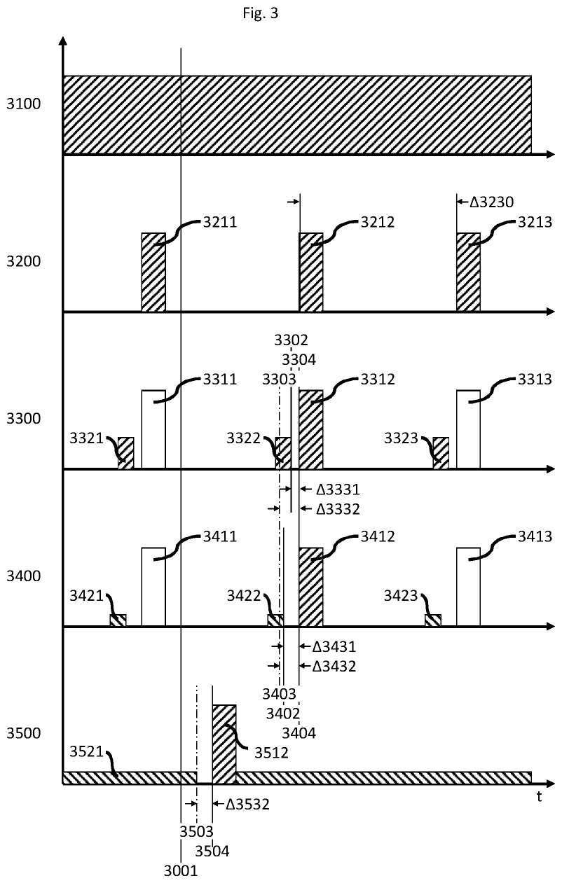

FIG. 3 illustrates examples of power modes 3100, 3200, 3300, 3400, 3500, in which a UE may operate.

Operation in power modes 3400, 3500 may involve using a low power receiver in addition to a main receiver, in particular in addition to a main transceiver. Power modes 3100, 3200, 3300 may also be used by a UE only including a main transceiver, in particular only a main receiver.

The main receiver may always be activated in power mode 3100. Thus, as indicated by the hatching from left below to top right, the UE may always communicate main signals with the main receiver. If data is available for communication at time 3001, the UE may immediately start communicating main signals using the main receiver.

Power mode 3200 may prescribe activating the main receiver according to a time schedule for pre-defined main signal time intervals 3211, 3212, 3213. Pre-defined may comprise that the point in time and/or length of the main signal time intervals 3211, 3212, 3213 is known to the UE before the UE actually operates in the power mode 3200. In some examples, the schedule for pre-defined main signal time intervals 3211, 3212, 3213 prescribes a periodic distribution of the main signal time intervals 3211, 3212, 3213. Thus, the UE may only communicate (i.e., receive and/or transmit) main signals within the main signal time intervals 3211, 3212, 3213. A length of a main signal time intervals may correspond to a DRX on duration. Compared to power mode 3100, power mode 3200 may consume less power. Accordingly, power mode 3200 may be considered a power safe mode. However, if data is available for communication at time 3001, the UE has to wait until main signal time interval 3212 before main signals may be communicated. Thus, power safe mode 3200 may imply a higher latency.

In power mode 3300, a main receiver may operate in a sleep mode and in an active mode. The power mode 3300 may prescribe operating the main receiver in a sleep mode according to a time schedule for pre-defined wake-up signal time intervals 3321, 3322, 3323. In response to detecting a wake-up signal 3303 in the wake-up signal time interval 3322, the UE may activate the main receiver according to a main signal time interval 3312, in which the UE is to communicate main signals.

The power mode 3300 may prescribe a pre-defined time schedule for main signal time intervals 3311, 3312, 3313. The pre-defined time schedule for wake-up signal time intervals 3321, 3322, 3323 may be specified in relation to the pre-defined time schedule for main signal time intervals 3311, 3312, 3313. For example, it may be specified that the wake-up signal time interval 3322 is to end at time 3302, which is x time units (e.g., time slots, time frames, milliseconds) before the point in time 3304, in which the main signal time interval 3312 starts. As indicated with the different height of the pre-defined wake-up signal time intervals 3321, 3322, 3323 compared to the pre-defined main signal time intervals 3311, 3312, 3313, the power consumption of the main receiver operating in sleep mode may be lower than the power consumption of the main receiver operating in active mode.

The UE may communicate, in response to detecting the wake-up signal 3303 in the pre-defined wake-up signal time interval 3312, a main signal in the main signal time interval 3312 of the pre-defined main signal time intervals 3311, 3312, 3313. In particular, the UE may communicate the main signal in a main signal time interval 3312 of the pre-defined main signal time intervals 3311, 3312, 3313 depending on the one pre-defined wake-up signal time interval 3322 of the pre-defined wake-up signal time intervals 3321, 3322, 3323, in which the wake-up signal 3303 is detected. For example, the UE may communicate the main signal in the main signal time interval 3312 which is the main signal time interval 3312 of the pre-defined main signal time intervals 3311, 3312, 3313 immediately following the wake-up signal time interval 3322, in which the wake-up signal 3303 is detected. Thus, the begin 3304 of the pre-defined main signal time interval 3312 does not depend on the time 3303 of detecting the wake-up signal 3303. It is the wake-up signal time interval 3322, in which the wake-up signal 3303 is detected, which determines which main signal time interval 3312 to use. The location of the main signal time intervals 3311, 3312, 3313 is pre-defined. Some aspects of the power mode 3400 may be similar to the power mode 3300. As explained hereinbefore, operation in power mode 3400 may involve using a low power receiver in addition to the main receiver/transceiver. A hatching from top left to right below may indicate an active low power receiver.

The power mode 3400 may prescribe a pre-defined time schedule for main signal time intervals 3411, 3412, 3413. A pre-defined time schedule for low power wake-up signal time intervals 3421, 3422, 3423 may be specified in relation to the pre-defined time schedule for main signal time intervals 3411, 3412, 3413. In the pre-defined time schedule for low power wake-up signal time intervals the UE is expected to listen for potential low power wake-up signal. In particular, a low power wake-up signal time interval may correspond to an interval, in which the network may wake-up the UE. Pre-defined may comprise that the point in time and/or length of the low power wake-up signal time intervals 3421, 3422, 3423 is known to the UE before the UE actually operates in the power mode 3400. For example, it may be specified that the low power wake-up signal time interval 3421 is to end at time 3402, which is x time units (e.g., time slots, time frames, milliseconds) before the point in time 3404, in which the main signal time interval 3412 starts. The time difference Δ3431 in power mode 3400 may be longer than the corresponding time difference Δ3331 power mode 3300 to take account for a longer time required for powering up a deactivated main receiver compared to a main receiver operating in sleep mode.

As indicated with the different height of the pre-defined low power wake-up signal time intervals 3421, 3422, 3423 compared to the pre-defined main signal time intervals 3411, 3412, 3413, the power consumption of the low power receiver may be significantly lower than the power consumption of the main receiver. In particular, the power consumption of the low power receiver may be even lower than the power consumption of the main receiver operating in sleep mode.

The UE may monitor for low power wake-up signals with the low power receiver in accordance with the time schedule of the pre-defined low power wake-up signal time intervals 3421, 3422, 3423. The UE may communicate, in response to detecting the low power wake-up signal 3403 in the pre-defined low power wake-up signal time interval 3422, a main signal in the main signal time interval 3412 of the pre-defined main signal time intervals 3411, 3412, 3413. In particular, the UE may communicate the main signal in a main signal time interval 3412 of the pre-defined main signal time intervals 3411, 3412, 3413 depending on the one of the pre-defined low power wake-up signal time intervals 3422, in which the low power wake-up signal 3403 is detected. For example, the UE may communicate the main signal in the main signal time interval 3412 which is the main signal time interval 3412 of the pre-defined main signal time intervals 3411, 3412, 3413 immediately following the low power wake-up signal time interval 3422, in which the low power wake-up signal 3403 is detected. Thus, the begin 3404 of the pre-defined main signal time interval 3412 does not depend on the time 3403 of detecting the low power wake-up signal 3403. It is the low power wake-up signal time interval 3422, in which the wake-up signal 3403 is detected, which determines which main signal time interval 3412 to use. The location in time of the main signal time intervals 3411, 3412, 3413 is pre-defined.

The low power receiver may have reduced capabilities compared to the main receiver/transceiver. Thus, a type of the low power wake-up signals may have to be less complex compared to a type of the main signals. For example, the low power wake-up signal may have to have a simpler modulation and coding scheme. For example, the low power wake-up signal is designed using on-off keying (OOK), binary frequency shift keying (BFSK), binary phase shift keying BPSK modulation. For example, the low power wake-up signal is a PN-sequenced or an m-sequence signal. Main signals may not be detectable and/or receivable and/or decodable by the low power wake-up receiver. The low power wake-up receiver may only be capable of receiving signals, in particular low power wake-up signals. In particular, the low power wake-up receiver may not be capable of transmitting any signals. According to the power modes 3200, 3300, 3400, a main signal may only be communicated in a pre-defined main signal time interval 3211, 3212, 3213; 3311, 3312, 3313; 3411, 3412, 3413. Thus, if data is available for communication at a point in time 3001, it may take a while until the data can actually be transmitted in the respective next pre-defined main signal time interval 3212, 3312, 3412. In some use cases, such a delay is not acceptable. Thus, there may be a need for a method allowing to balance power consumption and latency. According to power mode 3500, the UE monitors continuously for a low power wake-up signal 3503. In particular, a low power wake-up receiver may be activated all the time 3521. In examples, a maximum duration the UE continuously monitors for low power wake-up signals may be configured, e.g., by the AN. In response to detecting a lower power wake-up signal 3403, the UE may communicate a main signal in a main signal time interval 3512 that depends on a time of detecting the low power wake-up signal 3503. In particular, a start 3504 of the main signal time interval 3512 may depend on a time of detecting the low power wake-up signal 3503. More generally, the position of the main signal time interval 3512 in time may depend on a time of detecting the low power wake-up signal 3503. The main signal time interval 3512 is not pre-defined.

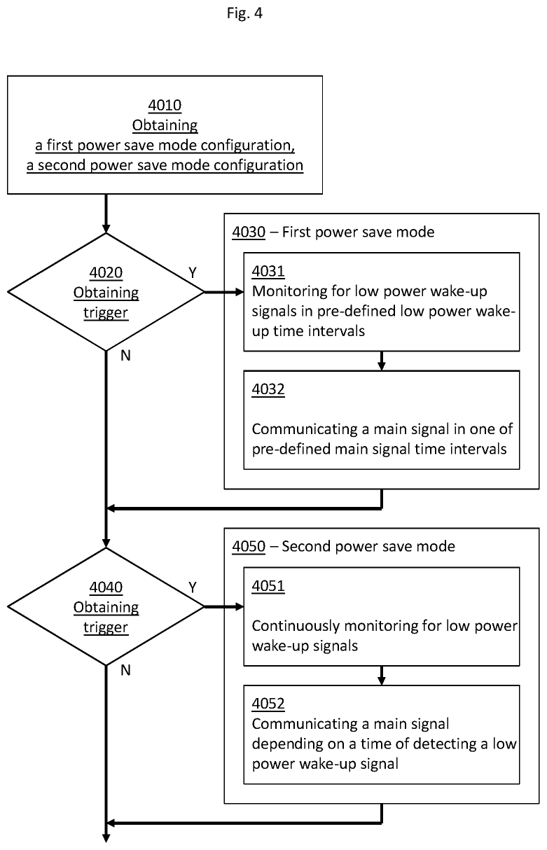

FIG. 4 in combination with FIG. 3 illustrates a method of operating a UE in a power save mode. At 4010, the UE obtains a first power save mode configuration indicative of a time schedule for pre-defined main signal time intervals 3411, 3412, 3413 and a time schedule for pre-defined low power wake-up signal time intervals 3421, 3422, 3423 and a second power save mode configuration associated with an always on operation. In some examples, the UE may obtain the first power save mode configuration by receiving messages from an AN relating to the first power save mode configuration. In other examples, the UE may obtain the first power save configuration by evaluating one or more criteria. An always on operation may imply that a low power wake-up receiver is always active, whereby continuously or continually monitoring for potential wake-up signal. An always on operation may imply that the UE may always monitor for potential low power wake-up signal. In particular, detecting a low power wake-up signal is not limited to a pre-defined low power wake-up signal time interval.

Upon obtaining a trigger 4020, the UE operates 4030 in the first power save mode 3400. In some examples, a trigger may relate to a message or signal received or detected by the UE (I.e., a trigger message or a trigger signal received from an AN). In some examples, the trigger may be the result of an evaluation performed by the UE (e.g., an evaluation that the UE is low on energy and, therefore, operate in the first power save mode 3400). A trigger may be result of at least one predefined rule or requirement. Operating 4030 the UE in the first power save mode 3400 comprises monitoring 4031 for low power wake-up signals 3403 in accordance with the time schedule of the pre-defined low power wake-up signal time intervals 3421, 3422, 3423, and communicating 4032, in response to detecting a low power wake-up signal 3403 in one of the pre-defined low power wake-up signal time intervals 3422, a main signal in a main signal time interval 3412 of the pre-defined main signal time intervals 3412, 3412, 3413.

Upon obtaining a trigger 4040, the UE operates 4050 in a second power save mode 3500. In some examples, a trigger may relate to a message or signal received or detected by the UE (I.e., a trigger message or a trigger signal received from an AN). In some examples, the trigger may be the result of an evaluation performed by the UE (e.g., an evaluation that a user wearing the UE is exercising and a critical health related value may have to be transmitted with a low latency and, therefore, operating the UE in the second power save mode 3500 is preferred). A trigger may be result of a predefined rules or requirement. Operating 4050 the UE in the second power save mode 3500 comprises continuously monitoring 4051 for a low power wake-up signal 3503, and communicating 4052, in response to detecting a low power wake-up signal 3503, a main signal in a main signal time interval 3512 that depends on a time of detecting the low power wake-up signal 3503.

Thus, the method according to FIG. 4 allows for balance power consumption and latency. In particular, the first power save mode 3400 may be advantageous with respect to power consumption as the low power wake-up receiver only needs to be activated during the low power wake-up signal time intervals. The second power save mode 3500 may lead to a reduced latency, because the low power wake-up signal may be sent any time. Moreover, the main signal time interval is not pre-defined in the power save mode 3500 such that the main signal time interval may start at a point in time which is closer to the time of detecting the low power wake-up signal.

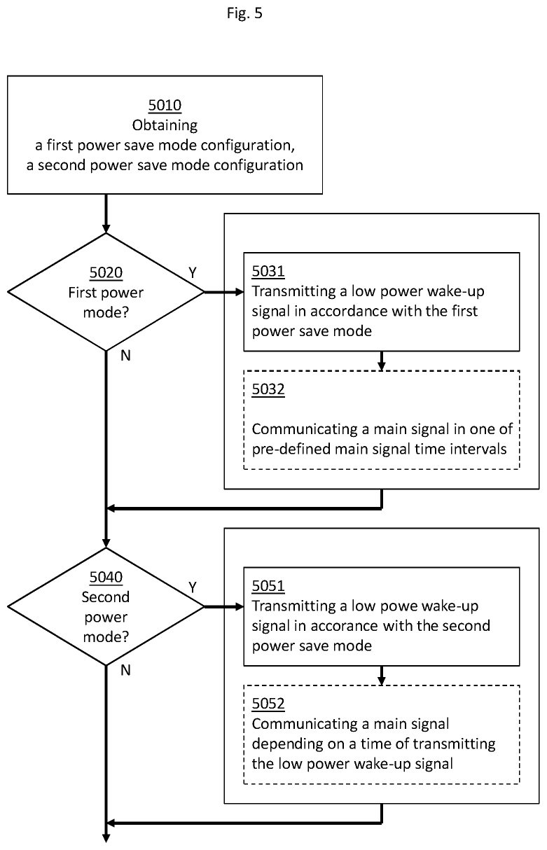

FIG. 5 in combination with FIG. 3 illustrates a method of operating an AN. At 5010, the AN obtains, for a UE, a first power save mode configuration indicative of a time schedule for pre-defined main signal time intervals 3411, 3412, 3413 and a time schedule for pre-defined low power wake-up signal time intervals 3421, 3422, 3423, and a second power save mode configuration associated with an always on operation.

Operating the UE in the first power save mode 3400 comprises monitoring 4031 for low power wake-up signals 3403 in accordance with the time schedule of the pre-defined low power wake-up signal time intervals 3421, 3422, 3423, and communicating 4032, in response to detecting a low power wake-up signal 3403 in one of the pre-defined low power wake-up signal time intervals 3422, a main signal in a main signal time interval 3412 of the pre-defined main signal time intervals 3412, 3412, 3413. Operating 4050 the UE in the second power save mode 3500 comprises continuously monitoring 4051 for a low power wake-up signal 3503, and communicating 4052, in response to detecting a low power wake-up signal 3503, a main signal in a main signal time interval 3512 that depends on a time of detecting the low power wake-up signal 3503.

Upon evaluating 5020 that the UE operates in the first power save mode 3400, the AN transmits 5031, to the UE, a low power wake-up signal in accordance with the first power save mode 3400. For example, the AN transmits 5031 the low power wake-up signal if the UE needs to be woken up. Optionally, the AN may communicate 5032, to the UE, a main signal in one of the pre-defined main signal time intervals 3412. Upon evaluation 5020 may refer to the AN becoming aware that the UE operates in the first power save mode 3400. Typically, both the AN and the UE have to be aware which power mode safe mode, is used. The UE requires said information to activate its low power wake-up receiver at the right time to be able to detect possible low power wake-up signals, the AN requires said information to send the wake-up signal at the right time, I.e. at a time the UE monitors for possible low power wake-up signals. Evaluating may refer to finding out that the UE operates in the first power save mode 3400. Evaluating may refer to receiving an explicit message, in particular from the UE, indicating that the UE operates in the first power save mode. However, it may also refer to an indirect information. For example, the AN may be aware that the UE has certain capabilities, e.g. the capability to operate according to the first power save mode, and that the UE is aware that latency requirements are relaxed at the moment. Then, the AN may evaluate that the UE is operating in the first power save mode as it is the most advantageous power mode at the moment.

Upon evaluating 5040 that the UE operates in the second power save mode 3500, the AN transmits 5051, to the UE, a low power wake-up signal in accordance with the second power save mode 3500. Optionally, the AN may communicate 5052, to the UE, a main signal in a main signal time interval 3512 that depends on a time of transmitting the low power wake-up signal 3503.

The advantages of the method of operating the AN according to FIG. 5 correspond to those of operating the UE according to FIG. 4.

The power save mode to be used by a UE may be determined according to different methods. Some use cases may prescribe an upper limit for a communication delay, i.e. a time between data to be transmitted to the UE becoming available at an access node (AN) and the possibility to transmit corresponding main signals from the AN to the UE such that they can be received by the UE. For example, with respect to FIG. 3, there may be an upper limit for the communication delay between the time 3001 at which data to be transmitted to the UE becomes available and following main signal time interval 3412, 3512, in which the UE can receive main signals. The upper limit for a communication delay may be denoted as t_{req-d}. Furthermore, a certain time may be required for activating the main receiver in response to detecting a low power wake-up signal. Said time may be called transition time tₜ. In addition, the pre-defined main time intervals may be provided according to a periodic schedule with a cycle time T. The cycle time T may correspond to the time difference 43230 shown in FIG. 3.

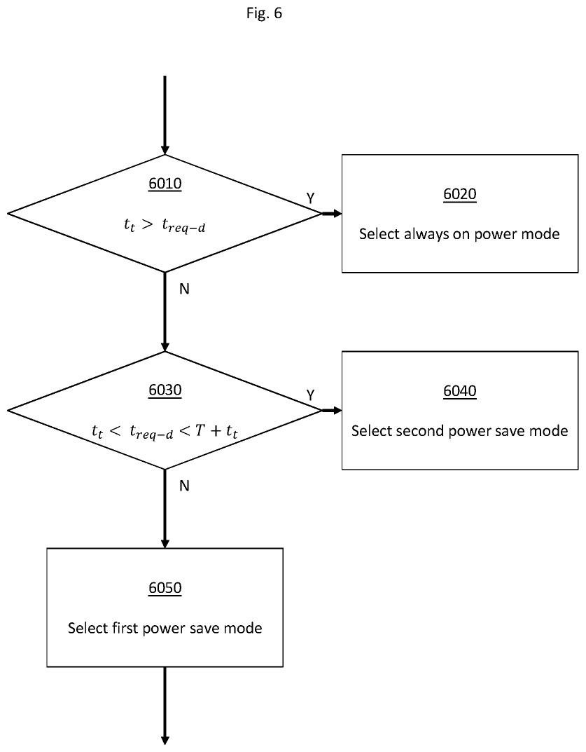

FIG. 6 illustrates a procedure, which may be used by the UE or the AN, for evaluating a power mode to be used by a UE. At 6010, the following formula is evaluated:

tₜ>t_{req-d}

If the formula is correct given the current values of t_{req-d} and tₜ, i.e. there is no sufficient time to wake-up the main receiver, a power mode is selected 6020 prescribing continuously operating the main receiver.

If the formula evaluated at 6010 is not correct, the following formula is evaluated at 6030

$${t}_{t} < {t}_{req - d} < T + {t}_{t}$$

If this formula is correct given the current values of tₜ, t_{req-d} and T, the second power save mode may be selected at 6040. Alternatively, a first power save mode configuration resulting in a different value T may be selected and the formula may be reevaluated with the new value for T.

In case the formula

$${t}_{t} < {t}_{req - d} < T + {t}_{t}$$

is incorrect given the current values of, t_{req-d} and T, the second power save mode may be selected at 6050.

The procedure for evaluating the power mode described with respect to FIG. 6 may be implemented by the UE and/or the AN.

As described hereinbefore with respect to FIG. 5, the UE communicates at least one main signal upon detecting a low power wake-up signal. The type and/or communication direction of the communicated main signals may depend on a type of the detected low power wake-up signal, in particular depending on information carried in the low power wake-up signal. For example, communicating main signals may include receiving a downlink (DL) control and/or a downlink data transmission, e.g., a reception of a paging or a normal DL message. In further examples, communicating main signals may include performing an uplink (UL) transmission, e.g. early data transmission (EDT) as specified in 36.321 Version 16.6.0, a small data transmission (SDT) and/or a minimization of drive test (MDT) as specified in 3GPP TS 37.320 Version 16.7.0. In still further examples, communicating main signals may include starting a random access procedure. For example, communicating main signals may comprise initiating a RACH procedure starting with a preamble transmission on the PRACH as specified in 3GPP TS 38.211 Version 17.0.0. In the other words, information in the low power wake-up signal may indicate the subsequent action.

The low power wake-up signal may be used for DL purposes and the subsequent action after detection of the low power wake-up signal may be a DL data reception. The DL data reception may require a PDCCH transmission prior to the DL data reception (PDSCH) or direct reception of DL data reception (PDSCH) in a preconfigured resource.

The AN may transmit the corresponding DL data after a certain time offset t_offset relative to the time of transmitting the low power wake-up signal. Thus, communicating, by the AN with the UE, a main signal may depend on a time of transmitting the low power wake-up signal.

The time offset t_{offset} needs to be larger than or equal to the transition time tₜ, which is required by the UE to activate its main receiver and perform synchronization.

The time offset t_{offset} may be a pre-configured value. In examples, the first power save mode configuration and/or the second power save mode configuration may be indicative of the time offset t_{offset}. The time offset t_{offset} may be selecting depending on a UE capability and/or a channel condition. For instance, depending on whether all parts of the main receiver are switched off or not, the power-up time and the time for preparing DL reception may vary. The time offset t_{offset} may correspond to the time difference Δ3532 indicated in FIG. 3. After the time offset t_{offset}, the UE may keep its main receiver on for a certain time period, tₒₙ, to receive the configuration for receiving the DL data (e.g., in a form of DL control channel) and/or the DL data. The on-duration tₒₙ may be a pre-configured value. In examples, the first power save mode configuration and/or the second power save mode configuration may be indicative of the on-duration tₒₙ. The on-duration tₒₙ in the second power save mode may have the same value as the duration of the pre-defined low power wake-up time interval in the first power save mode. For example, with respect to FIG. 3, the on-duration of the main signal time interval 3512 may have the same value as the on-duration of the main signal time interval 3412. In particular, the on-duration tₒₙ. may have the same duration/value as an on-duration of a normal DRX or C-DRX configuration.

In examples, the on-duration tₒₙ may be configured such that the UE may activate its main receiver for receiving the configuration for receiving the DL data, turn off its main receiver, and activate its receiver again for receiving the DL data. This may allow a further reduction of the power consumption and/or more possibilities for the AN and/or the communication network to schedule its DL transmission.

As explained hereinbefore, upon detecting a low power wake-up signal, the UE may transmit, to an AN, a main signal. The AN may expect to receive an uplink transmission within a certain time period t_{offset}^{UL} after the AN has sent the low power wake-up signal to the UE corresponding to a time of detecting the low power wake-up signal. Depending on the expected UL activity, i.e., whether the AN expects to receive an SDT, EDT, or PRACH, the assigned or reserved resources for UL transmission may be different. (e,g., if PUR is used, or a preamble is transmitted via PRACH).

The expected UL or DL activity, after detection of low power wake-up signal, may depend on the content of the low power wake-up signal, i.e., can be indicated in the low power wake-up signal or the expected UL or DL activity may be indicated by higher layer.

Obtaining the second power save mode configuration and/or triggering the operation of the UE in the second power save mode may be performed differently depending on the application and use cases. For applications or use cases with tight upper communication delays, such as an alarm induced by a fault occurring while manufacturing a product, the second power save mode configuration may be provided to the UE at the time of registration of the UE with the communication network. At the time of registration of the UE with the communication network, the UE may also receive a message triggering the UE to operate in the second power save mode. The core network of the communication network may inform the one or more of the ANs of the communication network, in particular radio access nodes (RANs), about the UEs capability.

For application such as wearable devices which can be used both for measuring vital signs (e.g., heart pulse) and other activities such as receiving text messages, obtaining the second power save mode configuration and/or triggering an operation of the UE in the second power save mode may comprise radio resource control (RRC).

Triggering and/or cancelling an operation of the UE in the second power save mode may be initiated by an AN of the communication network and/or the UE itself. Cancelling an operation of the UE in the second power save mode may include triggering the UE to operate in the first power save mode. As explained hereinbefore, operating the UE in the first power save mode may include operating the UE according to a legacy discontinuous reception (DRX) mode.

In some examples, the AN may cancel operation of the UE in the second power mode by transmitting a low power wake-up signal of a specific type, in particular containing certain information dedicated for this purpose. The low power wake-up signal may be detected by the UE's low power wake-up receiver. In further examples, canceling operation of the UE in the second power mode may include transmitting a main signal from the AN to the UE which may be received with the main transceiver of the UE. For example, information relating to the cancelling of an operation of the UE in the second power mode may be included in a downlink control indicator (DCI) provided to the UE via at least one main signal. In some examples, the AN may cancel operation of the UE in the second power mode after certain period of time where the UE does not receive any signals, including low power wake-up signal from the AN. The UE may switch to the first power mode.

Control circuitry connected to both the main transceiver and the low power wake-up receiver may trigger the UE to cancel operation in the second power mode. Switching operation in the second power save mode on or off may be used in use cases requiring, on the one hand, a short communication delay, e.g., when a manufacturing machine is running or while a person is exercising and wants to know exactly when the heart rate is passing a threshold, but, on the other hand, allow for a longer communication delay, e.g., when the manufacturing machine is idle or while the person is resting. The trigger switch on or off operation of the second power save mode may be set by the application

In some scenarios, the UE may cancel operating in the second power save mode when its stored energy is below a certain level or when the critical/short time delay can be relaxed for a certain time period. The UE may send a main signal to the AN, for example an SDT or EDT, to make the AN and/or the core network aware that the UE has cancelled operating in the second power save mode.

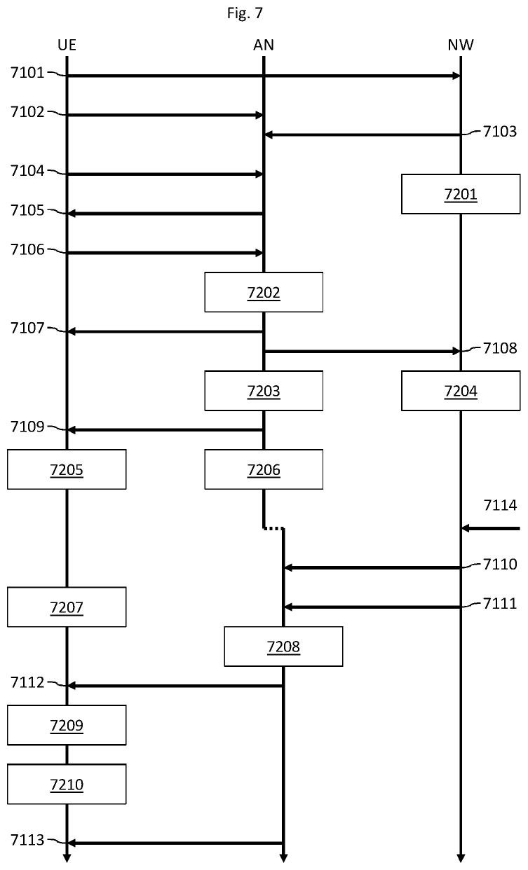

FIG. 7 schematically illustrates signaling in a communication network in accordance with examples of operating a UE in power save modes. Signaling does not necessarily happen in the exemplary order shown in FIG. 7.

Once the UE is connected to the communication network, the UE may provide a message 7101 indicative of the UE's non-radio capability to the communication network (NW), in particular to an AMF (Access and Mobility management Function) in 5GC or a mobility management entity (MME). The message 7101 may be provided to the AMF or to the MME using the non-Access-Stratum (NAS) protocol. Alternatively or in addition, the UE may provide the message 7102 indicative of the UE's non-radio capability to the serving AN. In examples, RRC signaling may be used for providing the message 7101 to the serving AN. For example, if the UE has an essentially static configuration (e.g., sensor, fire alarm sensor) and comparably tight delay requirements, the message 7101 may typically be provided to the MME. In scenarios in which the UE has a dynamic or semi-static configuration (e.g., wearable), the message 7102 may usually be provided to the serving AN.

In case the NW is aware of the UE's non-radio capabilities, the NW may provide a message 7103 to the serving AN indicative of the UE's capabilities.

The NW may store 7201 a UE context including the information related to the UE's capabilities non-radio capabilities.

Further, the UE may provide a message 7104 indicative of the UE's radio capabilities to the serving AN. For example, the message 7104 may be indicative of the UE being equipped with a low power wake-up receiver. Optionally, the message 7104 may also be indicative of a transition time tₜ required by the UE to activate its main transceiver in response to detecting a low power wake-up signal.

The AN may provide a message 7105 indicative of a second power save mode configuration to the UE. The message 7105 may be indicative of the AN supporting operation in the second power save mode. The message 7105 may be indicative of further parameters associated with an operation in the second power save mode. For example, the message 7105 may be indicative of one or more types of low power wake-up signals the UE may be expected to detect. For example, the message 7105 may be indicative of time-frequency resources, in which the low power wake-up signals are to be detected, of an encoding of information comprised in the low power wake-up signals.

The message 7105 may be provided using broadcast signals. The message 7105 may be provided in system information. In some examples, the message 7105 may be provided by before the message 7101 and/or the message 7102 are exchanged.

Further, during operation in idle mode and/or connected mode, the UE may optionally provide a message 7106 indicative of assistance information to the AN. The message 7106 may be indicative of a preferred first power save mode configuration (e.g., a preferred cycle time of periodic pre-defined low power wake-up signal time intervals and/or periodic pre-defined main signal time intervals, and/or a delay tolerance).

At 7202, the AN may evaluate based on predetermined criteria, in particular an upper limit of a required communication delay, and optionally based on the capability and/or assistance information to obtain a first power save mode configuration and/or a second power save mode configuration.

The UE may obtain a message 7107 indicative of the obtained first power save mode configuration and/or second power save mode operation from the serving AN. In examples, the message 7107 may be provided to the UE using RRC signaling. However, it may also be possible that the UE independently determines the first power save mode configuration and/or second power save mode configuration based on the capability and/or assistance information the UE has provided to the AN. Although the UE and the AN may determine the first power save mode configuration and/or second power save mode configuration independently from one another, as they may use the same decision criteria this will result in the same first power save mode configuration and/or second power save mode configuration determined by the UE and the AN

The AN may provide a message 7108 indicative of the UE's capability and/or assistance information provided by the UE and/or first power save mode configuration for the UE and/or second power save mode configuration to the NW, in particular to the MME. The NW may update 7204 the UE context based on the message 7108.

In some examples, the AN may also indicate explicitly to the UE whether the UE may operate in a power save mode during an in-active period.

Once the AN evaluates 7203 that there are no further main signal to be communicated between the UE and the AN, the AN may send a message 7109 to the UE for releasing the UE to idle. Generally, releasing the UE to idle may refer to releasing the UE to an RRC idle state or an RRC inactive state. Moreover, the AN may remove 7206 its UE context. The UE may enter an idle mode and based on a procedure illustrated in FIG. 5 enter the first power save mode or the second power save mode. In particular, the UE may deactivate the UE's main receiver and monitor 7207 for low power wake-up signals according to the first power save mode or the according to the second power save mode with the UE's low power wake-up receiver.

The NW, in particular the AMF or MME, may receive 7114 incoming/downlink data (from an application, cloud, etc.) for the UE of FIG. 7. The NW may then be providing to AN a message 7110 triggering the AN to provide said data to the UE. The AN may be the same that has exchanged one of the messages 7101 to 7109 with the UE. However, it may also be a different AN as indicated with the kink in the time lime.

The NW may also provide a message 7111 indicative of the UE context to the AN. The AN may store 7208 the UE context. The UE context may include the first power save mode configuration and the second power save mode configuration and information on the current power mode configuration, in which the UE operates.

Having obtained the first power save mode configuration and/or the second power save mode configuration and information on the power save mode configuration used by the UE, the AN may transmit a respective low power wake-up signal. The type of the transmitted low power wake-up signal may be indicative of the next action to be performed by the UE (e.g., monitor for paging signals or initiate a RACH procedure).

The UE may detect 7209, and optionally decode, the low power wake-up signal 7112 and activate 7210 the UE's main transceiver in accordance with the current power save mode. In a main signal time interval, the UE may then receive main signals 7113, for example paging signals. In particular, the UE may receive main signals corresponding to a DL control channel (e.g. paging PDCCH).

1. A method of operating a mobile device (UE) in a power save mode comprising:
obtaining a first power save mode configuration indicative of a time schedule for predefined main signal time intervals and a time schedule for pre-defined low power wake-up signal time intervals, and a second power save mode configuration associated with an always on operation;
operating the UE in a first power save mode upon obtaining a trigger for the UE to operate in the first power save mode, wherein operating in the first power save mode comprises:
monitoring for low power wake-up signals in accordance with the time schedule of the pre-defined low power wake-up signal time intervals; and
communicating, in response to detecting a low power wake-up signal in one of the pre-defined low power wake-up signal time intervals, a main signal in a main signal time interval of the pre-defined main signal time intervals, and
operating the UE in a second power save mode upon obtaining a trigger for the UE to operate in the second power save mode, wherein operating in the second power save mode comprises:
continuously monitoring for a low power wake-up signal; and
communicating, in response to detecting a low power wake-up signal, a main signal in a main signal time interval that depends on a time of detecting the low power wake-up signal.

2. The method of operating the UE in a power save mode of claim 1, further comprising:
providing, to an access node (AN) a message indicative of the UE supporting the first power save mode and/or the second power save mode.

3. The method of operating the UE in a power save mode of claim 1, further comprising
providing, to an or the AN, a message indicative of a request to change a power save mode.

4. The method of operating the UE in a power save mode of claim 1, wherein communicating a main signal comprising at least one of
transmitting a main signal depending on a type of the detected low power wakeup signal,
receiving a main signal depending on a type of the detected low power wake-up signal,
starting a random access procedure depending on a type of the detected low power wake-up signal.

5. The method of operating the UE in a power save mode of claim 1, wherein obtaining a trigger for the UE to operate in the second power save mode comprises at least one of:
evaluating, by the UE, a predetermined criterion, in particular an upper limit of a communication delay,
obtaining, from an or the AN, a message triggering the UE to operate in the second power save mode.

6. The method of operating the UE in a power save mode of claim 5, wherein obtaining, from an or the AN, a message triggering the UE to operate in the second power save mode comprises at least one of:
transmitting a main signal to the UE,
transmitting a low power wake-up signal to the UE.

7. The method of operating the UE in a power save mode of claim 1, wherein obtaining the first power save mode configuration and the second power save mode configuration comprises
obtaining, from an or the AN, at least one message indicative of the first power save mode configuration and/or the second power save mode configuration.

8. The method of operating the UE in a power save mode of claim 1, wherein communicating, in response to detecting a low power wake-up signal in one of the pre-defined low power wake-up signal time intervals, main signals in a main signal time interval of the pre-defined main signal time intervals comprises
communicating, in response to detecting a low power wake-up signal in one of the pre-defined low power wake-up signal time intervals, main signals in a main signal time interval of the pre-defined main signal time intervals depending on the one of the pre-defined low power wake-up signal time intervals, in which the low power wake-up signal is detected.

9. A method of operating an access node (AN) comprising
obtaining, for a mobile device (UE) a first power save mode configuration indicative of a time schedule for pre-defined main signal time intervals and a time schedule for pre-defined low power wake-up signal time intervals, and a second power save mode configuration associated with an always on operation;
wherein operating the UE in the first power save mode comprises:
monitoring for low power wake-up signals in accordance with the time schedule of the pre-defined low power wake-up signal time intervals; and
communicating, in response to detecting a low power wake-up signal in one of the pre-defined low power wake-up signal time intervals, main signals in a main signal time interval of the pre-defined main signal time intervals, and
wherein operating the UE in the second power save mode comprises:
continuously monitoring for a low power wake-up signal; and
communicating, in response to detecting a low power wake-up signal, main signals in a main signal time interval that depends on a time of detecting the low power wake-up signal.
transmitting, to the UE, a low power wake-up signal in accordance with the first power save mode upon evaluating that the UE operates in the first power save mode,
transmitting, to the UE, a low power wake-up signal in accordance with the second power save mode upon evaluating that the UE operates in the second power save mode.

10. The method of operating the AN of claim 9, further comprising:
communicating, with the UE, a main signal in one of the pre-defined main signal time intervals upon evaluating that the UE operates in the first power save mode,
communicating, with the UE, a main signal in a main signal time interval that depends on a time of transmitting the low power wake-up signal upon evaluating that the UE operates in the second power save mode.

11. The method of operating the AN of claim 9, further comprising:
obtaining, from the UE, a message indicative of the UE supporting the first power save mode and/or the second power save mode.

12. The method of operating the AN of claim 9, further comprising:
obtaining, from the UE, a message indicative of a request to change a power save mode,
providing, to the UE, a message triggering the UE to operate in a power save mode in accordance with the request to change the power save mode.

13. The method of operating the AN of claim 12, wherein providing, to the UE, a message triggering the UE to operate in a power save mode in accordance with the request to change the power save mode comprises at least one of:
transmitting a main signal to the UE,
transmitting a low power wake-up signal to the UE.

14. The method of operating the AN of claim 9, further comprising:
evaluating, by the AN, a criteria, in particular an upper limit of a required communication delay,
providing, to the UE, a message for triggering the UE to operate in the second power save mode.

15. The method of operating the AN of claim 14, wherein providing, to the UE, a message for triggering the U E to operate in the second power save mode comprises at least one of:
transmitting a main signal to the UE,
transmitting a low power wake-up signal to the UE.

16. The method of operating the AN of claim 9, wherein obtaining the first power save mode configuration comprises
adapting at least one of a time schedule for pre-defined main signal time intervals or a time schedule for pre-defined low power wake-up signal time intervals to an upper limit of a communication delay.

17. A mobile device (UE) comprising control circuitry, wherein the control circuitry is configured for performing the method of claim 1.

18. The UE of claim 17, further comprising
a main receiver, in particular a main transceiver, configured for communicating main signals;
a low power wake-up receiver configured for detecting low power wake-up signals,
wherein the control circuitry is further configured for
activating the main receiver in the main signal time interval that depends on the time of detecting the low power wake-up signal.

19. The UE of claim 17, wherein the control circuitry is configured for continuously activating the low power wakeup receiver or activating the low power wake-up receiver only according to pre-defined low power wake-up signal time intervals.

20. An access node (AN) comprising control circuitry, wherein the control circuitry is configured for performing the method of claim 9.
